(19) United States
(12) Patent Application Publication
(10) Pub. No.: US 2024/0166167 A1
(43) Pub. Date: May 23, 2024

(54) DEVICE FOR CLEANING A SURFACE BY MEANS OF A MOVABLE DEFLECTED JET

(71) Applicant: VALEO SYSTEMES D'ESSUYAGE, La Verriere (FR)

(72) Inventors: Margaux BEAUBET, La Verriere (FR); Julien CARRION, La Verriere (FR)

(73) Assignee: VALEO SYSTEMES D'ESSUYAGE, La Verriere (FR)

(21) Appl. No.: 18/548,720

(22) PCT Filed: Feb. 28, 2022
(86) PCT No.: PCT/EP2022/055015

§ 371 Date: Sep. 1, 2023

(30) Foreign Application Priority Data
Mar. 1, 2021 (FR) 2101944

(51) Int. Cl. B60S 1/52; B60S 1/56

(52) U.S. Cl. CPC B60S 1/52; B60S 1/56

(57) ABSTRACT

Cleaning device for projecting a cleaning fluid toward a surface of an optical sensor, including a hollow body with an intake port for the cleaning fluid and an ejection nozzle for ejecting the cleaning fluid in the form of a jet, the hollow body being pierced with a conduit for distributing the cleaning fluid, and a deflection element arranged downstream of the ejection nozzle and configured to obstruct the jet of fluid ejected by the ejection nozzle in such a way as to modify the orientation of the jet of fluid with respect to the surface to be cleaned. The deflection element is adapted to move, depending on the pressure to which it is subjected by the jet of fluid, between a near position, in which the deflection element is next to the ejection nozzle, and a moved-away position, in which the deflection element is away from the ejection nozzle.

### TECHNICAL FIELD

The present disclosure relates to a cleaning device, intended to project a jet of cleaning fluid toward a surface to be cleaned of a motor vehicle, such as an optical surface of a sensor of an optical detection system, the cleaning device including a hollow body comprising an upstream side provided with an intake port for the cleaning fluid and a downstream side provided with an ejection nozzle for ejecting the cleaning fluid in the form of a jet in the direction of the surface to be cleaned, the hollow body being pierced with a conduit for distributing the cleaning fluid from the intake port to the ejection nozzle, and a cleaning fluid jet deflection element arranged downstream of the ejection nozzle and configured to obstruct the jet of fluid ejected by the ejection nozzle in such a way as to modify the orientation of the jet of fluid with respect to the surface to be cleaned.

### BACKGROUND OF THE INVENTION

Such a cleaning device is known from document FR 3 056 517 A1, see FIGS. 1 to 3 in particular.

In this known cleaning device, the ejection nozzle is formed in a telescopic movable element which, during cleaning, is deployed out of a hollow receiving body. By deploying the movable element, the ejection nozzle is brought to a position above the surface to be cleaned. Thus, the jet of cleaning fluid ejected by the nozzle reaches the entire surface to be cleaned. This ensures that the entire surface is cleaned properly.

However, this type of telescopic cleaning device is expensive, complex and fragile, owing to its kinematics, and the large number of parts.

Document DE 41 09 443 A1 discloses another example of a telescopic cleaning device.

### SUMMARY OF THE INVENTION

It is therefore an aim of the present disclosure to propose a cleaning device which is simpler, more reliable and less expensive, while ensuring effective cleaning of the entire surface to be cleaned.

According to the present disclosure, this aim is achieved by a cleaning device as defined in paragraph above, which is characterized in that the deflection element is adapted to move, depending on the pressure to which it is subjected by the jet of fluid, between a near position, in which the deflection element is next to the ejection nozzle, and a moved-away position, in which the deflection element is away from the ejection nozzle.

By virtue of the movable deflection element, the orientation of the jet of liquid with respect to the surface to be cleaned may modify the zone of impact of the jet of fluid on the surface to be cleaned. All that is required is to vary the pressure of the jet of fluid at its nozzle outlet. Thus, the jet of fluid is made to sweep the surface to be cleaned, which ensures effective cleaning. At the same time, with the cleaning device according to the present disclosure, a telescopic mechanism is not necessary, which reduces cost and complexity.

Note that in the moved-away position, the outlet opening of the ejection nozzle is completely unobstructed. In other words, the outlet opening of the nozzle is completely free of the deflection element. Note that in the moved-away position, the deflection element does not interfere with the jet of fluid at the outlet opening of the ejection nozzle.

Note that in the moved-away position, the deflection element is at a distance from the ejection nozzle. To be specific, in the moved-away position, the deflection element is at a distance from the outlet opening of the ejection nozzle.

For example, the deflection element is arranged at a predetermined distance from the ejection nozzle.

The features described in the paragraphs below can, as desired, be implemented independently of one another or in combination with one another:

A path of movement of the deflection element between the near position and the moved-away position is curved;
The ejection nozzle is stationary in relation to the surface to be cleaned;
The deflection element comprises a strip;
Note that the deflection element comprises an elongate portion;
The deflection element closes off the ejection nozzle in the near position;
The cleaning device comprises a stop which limits the movement of the deflection element, the deflection element bearing on the stop in the moved-away position;
In the moved-away position, the distance between the nozzle and the deflection element is determined by the position of the stop;
In the moved-away position, the strip bears against the stop;
The stop and the hollow body are in one piece;
The deflection element has a first end via which it is secured to the hollow body, and a free second end opposite the first end;
What is meant by second end of the deflection element is an end portion of the strip;
Note that the elongate portion of the deflection element extends between the first end and the second end;
Note that in the near position, the second end is configured to close off the ejection nozzle;
Note that the second end is configured to move between the moved-away position and the near position;
Note that the path of movement of the second end is curved; the deflection element is a flexible element which deforms elastically under the pressure exerted by the jet of fluid;
In the moved-away position, the strip of the deflection element comprises a curved portion;
During the movement of the strip from the near position to the moved-away position, a portion of the strip is configured to bend;
The movement of the deflection element is a pivoting about a pivot connection;
The deflection element comprises a return means for returning to the near position, such as a spring;
The strip is rigid;
The deflection element is made of carbon, stainless steel, elastomer or plastic.

The present disclosure also relates to an optical detection system for a motor vehicle, comprising a sensor provided with an optical surface, and a device for cleaning the optical surface as defined above.

### BRIEF DESCRIPTION OF THE DRAWINGS

Further features, details and advantages will become apparent on reading the detailed description below, and on studying the attached drawings, in which:

FIG. 1 is a view in cross section of a first embodiment of a cleaning device according to the present disclosure with a deflection element in the near position.

FIG. 2 is a view in cross section of the first embodiment of FIG. 1 with the deflection element in the moved-away position.

FIG. 3 is a view in cross section of a second embodiment of the cleaning device according to the present disclosure with a deflection element in the near position.

FIG. 4 is a view in cross section of the second embodiment of FIG. 3 with the deflection element in a first intermediate position.

FIG. 5 is a view in cross section of the second embodiment of FIG. 3 with the deflection element in a second intermediate position.

FIG. 6 is a view in cross section of the second embodiment of FIG. 3 with the deflection element in the moved-away position.

### DETAILED DESCRIPTION OF THE INVENTION

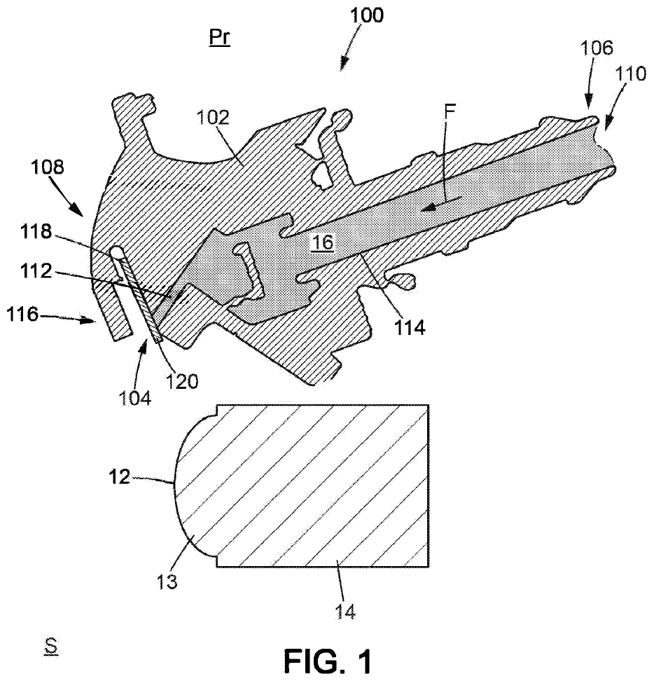

The cleaning devices 100, 200 shown in FIGS. 1 to 6 are intended to project a jet 10 of cleaning fluid toward a surface 12 to be cleaned of a motor vehicle, such as an optical surface of a sensor 14 of an optical detection system. Typically, these cleaning devices 100, 200 are mounted on a motor vehicle in the vicinity of an associated sensor 14 to be cleaned.

In the present context, optical detection system is the name given to any system including one or more optical sensors, such as cameras, laser sensors (commonly referred to as LIDAR) or other sensors based on the emission and/or the detection of light in the spectrum visible or invisible to humans, in particular the infrared. Such optical detection systems are being fitted on an increasingly large number of motor vehicles in order to assist the driver of the vehicle in certain driving situations, parking assistance being a well known example of such a situation. In order for this assistance to be as effective as possible, the data supplied by the optical detection system have to be of the best possible quality, and it is therefore essential to have clean optical systems to perform these data acquisitions.

To this end, the cleaning devices 100, 200 according to the present disclosure may be commanded to spray the surface 12 to be cleaned (for example, the surface of a lens 13 of a camera 14 for taking pictures) with a cleaning fluid, for example just before the detection is carried out (for example, the taking of a picture).

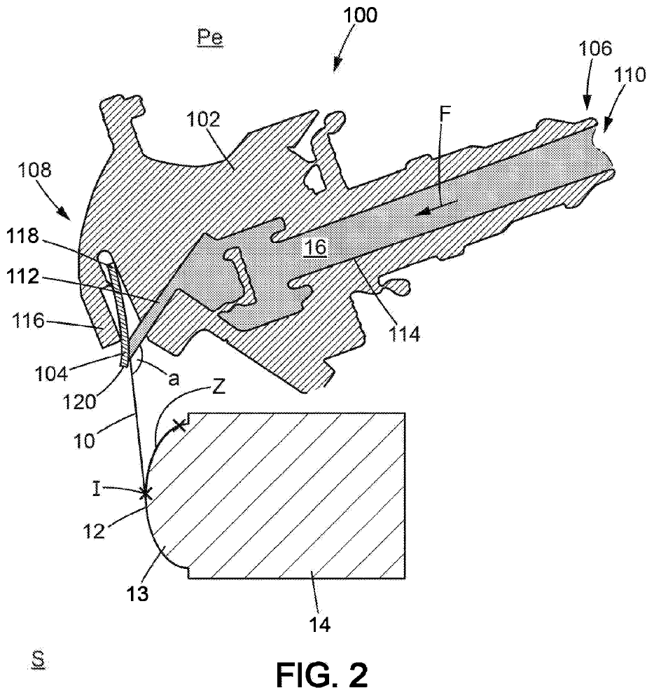

FIGS. 1 and 2 illustrate a first embodiment 100 of the cleaning device according to the present disclosure.

The cleaning device 100 comprises a hollow body 102, and a deflection element 104 mounted on the hollow body 102.

The hollow body 102 has an upstream side 106 and a downstream side 108. The “upstream” and “downstream” positions are defined relative to the direction F in which fluid flows within the hollow body 102. The upstream side 106 of the hollow body 102 is provided with an intake port 110 for cleaning fluid 16. The downstream side 108 is provided with an ejection nozzle 112 for ejecting the cleaning fluid 16 in the form of a jet 10. The hollow body 102 is pierced with a conduit 114 for distributing the cleaning fluid 16 from the intake port 110 to the ejection nozzle 112. The ejection nozzle 112 is formed in the hollow body 102. A stop 116 is arranged facing the ejection nozzle 112. Preferably, the stop 116 and the hollow body 102 are in one piece. Alternatively, the stop 116 and the hollow body 102 may take the form of two individual parts, one secured to the other.

The deflection element 104 is arranged downstream of the ejection nozzle 112 and configured to obstruct the jet of fluid 10 ejected by the ejection nozzle 112 in such a way as to modify the orientation of the jet of liquid with respect to the surface to be cleaned 12. The deflection element 104 is adapted to move, depending on the pressure to which it is subjected by the jet of fluid 10, between a near position Pr shown in FIG. 1 and a moved-away position Pe shown in FIG. 2. In the near position Pr (see FIG. 1), the deflection element 104 is next to the ejection nozzle 112. In the moved-away position Pe (see FIG. 2), the deflection element 104 is away from the ejection nozzle 112.

In the example shown in FIGS. 1 and 2, the deflection element 104 is made in the form of a strip. This strip 104 has a first end 118, via which it is secured to the hollow body 102. It also has a free second end 120 opposite the first end 118.

The strip 104 may be made of carbon, stainless steel, elastomer or plastic, inter alia.

According to the first embodiment of FIGS. 1 and 2, the strip 104 is a flexible element which deforms elastically under the pressure exerted by the jet of fluid 10. In other words, said strip 104 is adapted to move by elastic deformation, depending on the pressure to which it is subjected by the jet of fluid 10, between a near position Pr shown in FIG. 1 and a moved-away position Pe shown in FIG. 2. The elastic deformation of the strip 104 consists, for example, in that a portion of said strip bends according to the pressure to which it is subjected by the jet of fluid 10. Thus, when the strip 104 is in the moved-away position Pe, at least a portion of the strip has a curvature.

FIGS. 1 and 2 show not only the cleaning device 100 but also an optical sensor 14 to be cleaned by the cleaning device 100. Typically, the cleaning device 100 and the optical sensor 14 are both mounted together in a motor vehicle, close to one another. The cleaning device 100 and the optical sensor 14 thus form an optical detection system S.

The optical sensor 14 is for example a camera which has a lens 13. In this case, it is the convex surface 12 of the lens 13 which is cleaned by the cleaning device 100.

The operation of the cleaning device 100 of FIGS. 1 and 2 will now be described.

When the cleaning device 100 is at rest, the strip 104 is in the near position Pr (see FIG. 1) and closes off the ejection nozzle 112. When the cleaning device 100 is started up by pumping cleaning fluid 16 to the ejection nozzle 112, the hydraulic pressure within the delivery conduit 114 increases. This pressure is experienced by the strip 104. Consequently, as the pressure increases, the strip 104 deforms elastically and its free end 120 moves away from the ejection nozzle 112.

The outlet opening of the ejection nozzle 112 is therefore cleared and a jet 10 of cleaning fluid is ejected from the nozzle 112, strikes against the free end 120 of the strip 104, and is deflected toward the optical surface 12.

The strip 104 continues to deform until the free end 120 comes into abutment against the stop 116. The stop 116 limits the deformation of the strip 104, which is then in the moved-away position Pe (see FIG. 2). As the strip 104 moves from the near position Pr into the moved-away position Pe, the angle of deflection a (see FIG. 2) of the jet of fluid 10 varies from a minimum value to a maximum value. Consequently, the point of impact I of the jet of fluid 10 on the optical surface 12 changes. In other words, during cleaning, the jet of fluid 10 sweeps a zone Z of the optical surface 12 to be cleaned. Cleaning of the optical surface 12 is also improved.

It will therefore be understood that the movable deflection element 104 makes it possible to modify the orientation of the jet of fluid 10 with respect to the surface to be cleaned 12 and thus to spray an entire zone Z of the surface 12 to be cleaned.

By providing different modes of control of a pump conveying the cleaning fluid 16 to the hollow body 102, it is possible to implement different cleaning programs. For example, it is possible to provide a cleaning program with intermittent pumping of the pump which results in a to-and-fro or swinging movement of the strip 104 between these two end positions Pr and Pe and thus in repeated sweeping of the cleaning zone Z by the jet of fluid 10.

Furthermore, the flexibility of the strip 104 may be adapted to suit the specific application desired. Thus, by giving it a predetermined flexibility, the behavior of the strip 104 may be adjusted according to the pressure exerted by the jet of fluid 10. In this way, it is possible to modify the sweeping performed by the strip 104.

Note that, unlike known telescopic cleaning devices, according to the present disclosure, the ejection nozzle 112 remains stationary in relation to the surface to be cleaned 12 when the cleaning device is activated, just as when the cleaning device 100 is at rest.

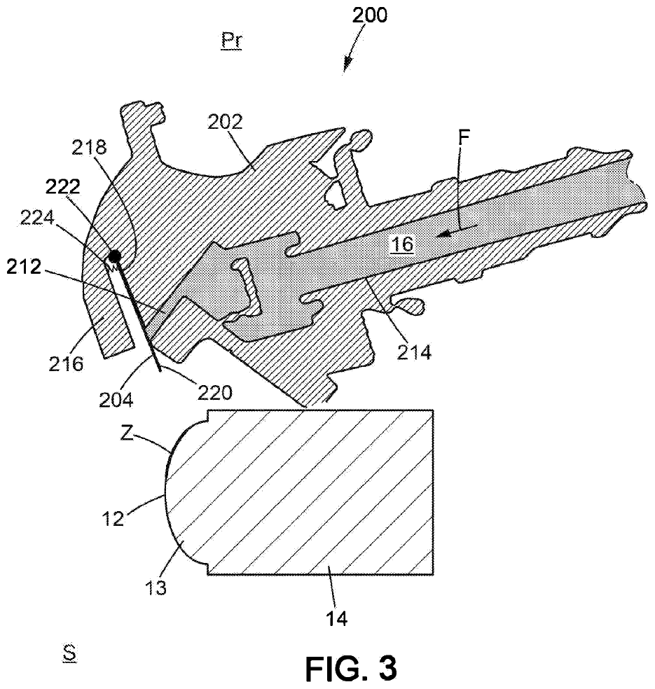

With reference to FIGS. 3 to 6, a second embodiment 200 of the cleaning device according to the present disclosure will now be described. Only the differences found in the second embodiment 200 compared to the first embodiment 100 will be highlighted here. For the elements which are similar, refer to the description above and to FIGS. 1 and 2.

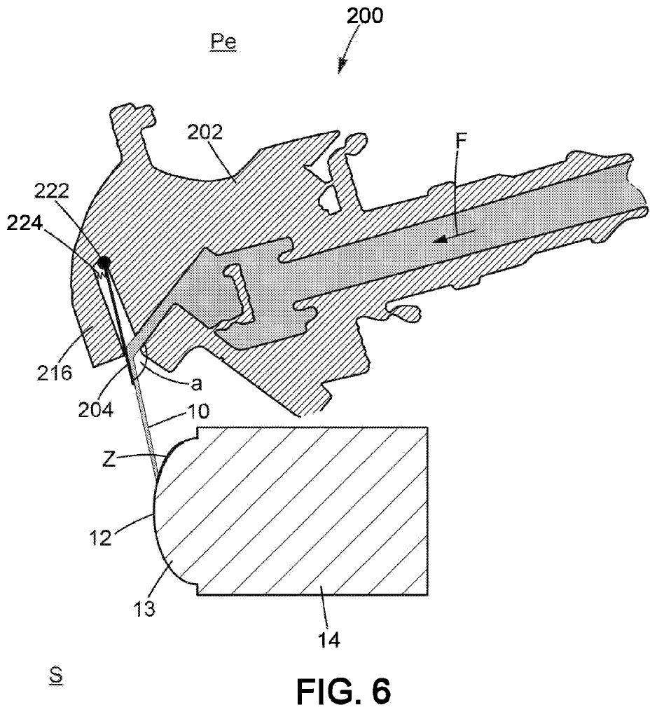

In this second embodiment, the strip 204 is a rigid element. The rigid strip 204 moves, between a near position Pr shown in FIG. 3 and a moved-away position Pe shown in FIG. 6, by pivoting about a pivot connection 222. The rigid strip 204 is secured to the hollow body 202 by means of the pivot connection 222, which is located at the first end 218 of the rigid strip 204. A return means 224 (in this case a spring) for returning the strip 204 to the near position Pe is provided between the strip 204 and the hollow body 202. A first end of the return means 224 bears against the hollow body 202, and a second end of the return means 224 bears against the rigid strip 204. In this second embodiment, note that the deflection element comprises the rigid strip 204, the pivot connection 222 and the return means 224.

The second embodiment 200 works as follows:

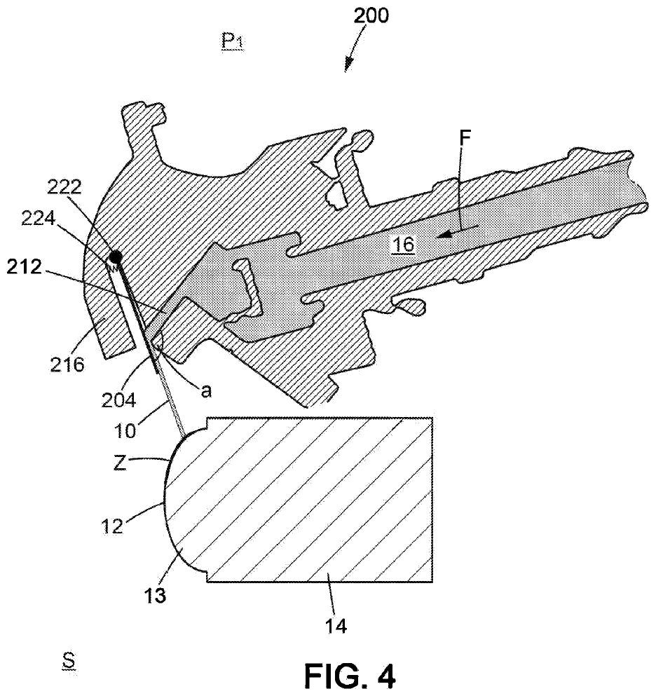

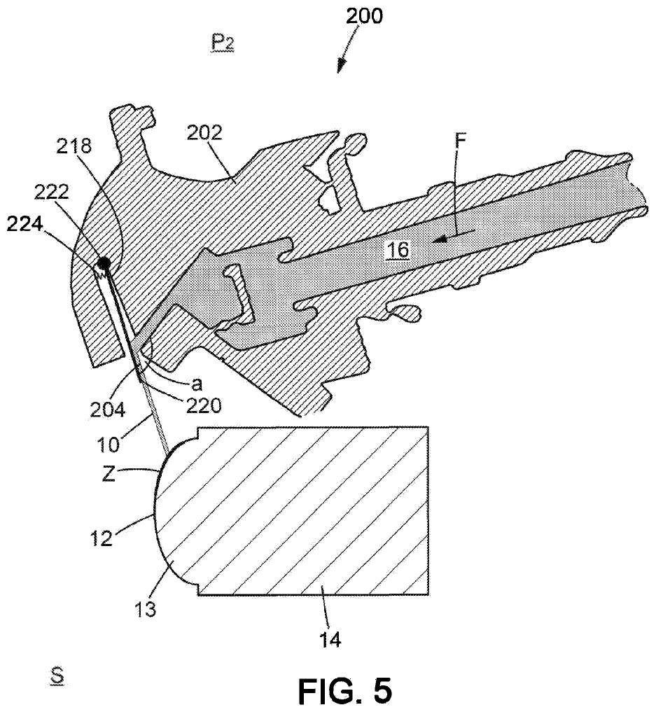

When at rest, as shown in FIG. 3, the rigid strip 204 is in the near position Pr and closes off the ejection nozzle 212. When the optical surface 12 needs to be cleaned, cleaning fluid 16 is pumped to the ejection nozzle 212. The resulting increased pressure acts on the strip 204 which then begins to move away from the ejection nozzle 212. Thus, the strip 204 pivots from its near position Pr (see FIG. 3) into its moved-away position Pe (see FIG. 6), before ultimately pressing against the stop 216. Over this path, the strip 204 passes through intermediate positions. Two of its intermediate positions P1 and P2 are shown in FIGS. 4 and 5. The strip 204 therefore pivots from position Pr to position P1, then to position P2, and comes to the end of its path in position Pe. This results in a decreasing deflection of the jet of fluid 10 which, consequently, sweeps an entire zone Z of the optical surface 12. The changing angle of deflection of the jet of fluid 10 is indicated in FIGS. 4 to 6 by the reference a. At the end of cleaning, pumping of cleaning fluid 16 is stopped and the strip 204 returns to its near position Pr under the action of the return spring 224.

The stiffness of the return spring 224 may be adapted to suit the specific application desired. Thus, by selecting a predetermined spring stiffness, the behavior of the strip 204 may be adjusted according to the pressure exerted by the jet of fluid 10. In this way, it is possible to modify the sweeping performed by the strip 204.

The cleaning device 100, 200 according to the present disclosure is advantageous, in particular in that it comprises few components and few moving parts. It is also inexpensive, compact and easy to integrate.

What is claimed is:

1. A cleaning device, intended to project a jet of cleaning fluid toward a surface to be cleaned of a motor vehicle, such as an optical surface of a sensor of an optical detection system, the cleaning device comprising:
a hollow body including an upstream side provided with an intake port for the cleaning fluid and a downstream side provided with an ejection nozzle for ejecting the cleaning fluid in the form of a jet in the direction of the surface to be cleaned, the hollow body being pierced with a conduit for distributing the cleaning fluid from the intake port to the ejection nozzle; and
a cleaning fluid jet deflection element arranged downstream of the ejection nozzle and configured to obstruct the jet of fluid ejected by the ejection nozzle in such a way as to modify the orientation of the jet of fluid with respect to the surface to be cleaned,
wherein the deflection element is adapted to move, depending on the pressure to which it is subjected by the jet of fluid, between:
a near position, in which the deflection element is next to the ejection nozzle; and
a moved-away position, in which the deflection element is away from the ejection nozzle.

2. The cleaning device as claimed in claim 1, wherein the deflection element comprises an elongate portion.

3. The cleaning device as claimed in claim 1 wherein the deflection element is at a distance from an outlet opening of the ejection nozzle.

4. The cleaning device as claimed in claim 1, wherein a path of movement of the deflection element between the near position and the moved-away position is curved.

5. The cleaning device as claimed in claim 1, wherein the ejection nozzle is stationary in relation to the surface to be cleaned.

6. The cleaning device as claimed in claim 1, wherein the deflection element closes off the ejection nozzle in the near position.

7. The cleaning device as claimed in claim 1, further comprising a stop which limits the movement of the deflection element, the deflection element bearing on the stop in the moved-away position.

8. The cleaning device as claimed in claim 7, wherein the stop and the hollow body are in one piece.

9. The cleaning device as claimed in claim 1, wherein the deflection element has a first end via which it is secured to the hollow body, and a free second end opposite the first end.

10. The cleaning device as claimed in claim 1, wherein the deflection element is a flexible element which deforms elastically under the pressure exerted by the jet of fluid.

11. The cleaning device as claimed in claim 1, further comprising a return means for returning the deflection element to its near position.

12. The cleaning device as claimed in claim 1, wherein the deflection element is made of carbon, stainless steel, elastomer or plastic.

13. An optical detection system for a motor vehicle, comprising a sensor provided with an optical surface, and a device for cleaning the optical surface that includes:
a hollow body including an upstream side provided with an intake port for the cleaning fluid and a downstream side provided with an ejection nozzle for ejecting the cleaning fluid in the form of a jet in the direction of the surface to be cleaned, the hollow body being pierced with a conduit for distributing the cleaning fluid from the intake port to the ejection nozzle; and
a cleaning fluid jet deflection element arranged downstream of the ejection nozzle and configured to obstruct the jet of fluid ejected by the ejection nozzle in such a way as to modify the orientation of the jet of fluid with respect to the surface to be cleaned,
wherein the deflection element is adapted to move, depending on the pressure to which it is subjected by the jet of fluid, between:
a near position, in which the deflection element is next to the ejection nozzle; and
a moved-away position, in which the deflection element is away from the ejection nozzle.

14. The cleaning device as claimed in claim 11, wherein the return means is a spring.
